(19) United States
(12) Patent Application Publication
(10) Pub. No.: US 2008/0126386 A1
(43) Pub. Date: May 29, 2008

(54) TRANSLATION OF ELECTRONIC DATA INTERCHANGE MESSAGES TO EXTENSIBLE MARKUP LANGUAGE REPRESENTATION(S)

(75) Inventors: Suraj Gaurav, Issaquah, WA (US); Surendra Machiraju, Issaquah, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/533,626

(22) Filed: Sep. 20, 2006

(51) Int. Cl. G06F 17/30

(52) U.S. Cl. 707/102; 707/E17.044

(57) ABSTRACT

Configurable options are provided for translating EDI interchange files to a single XML representation covering all transaction sets in the interchange or multiple XML representations with one XML representation per transaction set in the interchange. Optionally, translation combines EDI transaction sets of an interchange into a single XML representation while preserving the EDI structure. Optionally, where a single XML document is generated, the single XML document includes as part of translation only transaction sets that are error-free. Optionally, if any of the transaction sets includes an error, all transaction sets of an interchange are rejected.

### TECHNICAL FIELD

The subject disclosure relates to the translation of electronic data interchange (EDI) message(s) to extensible markup language (XML) representation(s) by an EDI communications system.

### BACKGROUND

Traditionally, with EDI, organizations have been empowered to send virtually limitless kinds of structured messages to one another to facilitate the communication of any kind of business data from one organization to another in automated ways. In this regard, once setup properly, EDI messages can be used to automate a variety of communications to and from partners, business sub-units, buyers, etc., thereby substantially reducing the overhead associated with filling out paper forms, storing volumes of papers, etc. With EDI, for instance, an organization merely fills out an electronic form in a manner conforming to a pre-defined schema, called a transaction set definition (TSD), and then the messaging, storage/record keeping and validation of the message(s) associated with the electronic form occurs automatically.

In current EDI messaging scenarios, which applies to both inbound messages (i.e., where a message is received by an organization) and to outbound messages (i.e., where a message is transmitted from an organization to an intended recipient of the message), a single message can be addressed for multiple parties, and multiple messages can be received from different parties. Multiple messages can also be received from the same party as part of an Interchange, which is an EDI flat file representation of multiple transaction sets. In this regard, EDI data in its native flat file representation is generally transmitted as delimited files, without self-describing tags, and therefore the encoding rules enforce very strict formatting rules to ensure the destination application is able to successfully parse and consume the information for down stream processing. Such files are hardly in an easily human readable form.

The structure of a typical interchange 1400 is illustrated in FIG. 14A. An interchange file, such as interchange 1400 begins with ‘ISA’ and ends in ‘IEA’ and then contains one or more intermediate groups of Transaction Sets, which begin with ‘GS’ and end with ‘GE. Each group then contains one or more Transaction Sets, each of which begins with ‘ST’ and ends with ‘SE’. Interchange file 1400, as shown, has three Transaction Sets 1402, 1404 and 1406. Today, when a translator component 1410 of an EDI system receives an interchange file, such as interchange file 1400, and translates the interchange file 1400 to an XML representation, translator 1410 breaks out each transaction set payload into separate XML files 1422, 1424 and 1426 for further consumption by the EDI system in some fashion.

However, as shown in FIG. 14B, if one of the transaction set payloads, such as transaction set 1406, includes an error in its data, such as bad data 1430, which does not conform to the appropriate TSD or is rejected for some other reason, then today, translator 1410 will suspend, i.e., not translate, any XML representations for any transaction sets containing errors, such as transaction set 1406. Thus, where transaction set 1406 of interchange 1400 includes an error, when translating interchange 1400 to XML files, translator 1410 only produces XML files 1422 and 1424 for valid transaction sets 1402 and 1404, respectively, but not for the transaction set 1406, i.e., XML file 1426 is not generated. Currently, FIG. 14B represents the only option for translating interchanges to XML files in the presence of errors.

In this respect, there is no flexibility to handle errors in any other fashion when translating an interchange received by an EDI system to XML. Moreover, the order of the Transaction Sets in the Interchange might be considered important by an application or service, and thus always breaking the Transaction Sets into individual representations leads to loss of such ordering information.

Accordingly, in consideration of the deficiency of the state of the art of interchange translation techniques in an EDI communications system, improved ways for translating groups of EDI transaction sets in the presence of errors are desired. The above-described and other deficiencies in the state of the art of EDI messaging will become apparent upon description of the various exemplary non-limiting embodiments of the invention set forth in more detail below.

### SUMMARY

In consideration of the foregoing, the invention provides configurable options for translation of interchange(s) to a single XML representation covering all transaction sets in the interchange or to multiple XML representations with one XML representation per transaction set in the interchange. Optionally, translation combines EDI transaction sets of an interchange into a single XML representation while preserving the EDI structure. In one embodiment, the single XML document includes as part of translation only transaction sets that are error-free. Optionally, if any of the transaction sets includes an error, all transaction sets of an interchange are rejected.

A simplified summary is provided herein to help enable a basic or general understanding of various aspects of exemplary, non-limiting embodiments that follow in the more detailed description and the accompanying drawings. This summary is not intended, however, as an extensive or exhaustive overview. The sole purpose of this summary is to present some concepts related to the various exemplary non-limiting embodiments of the invention in a simplified form as a prelude to the more detailed description that follows.

### BRIEF DESCRIPTION OF THE DRAWINGS

The system and methods for translating interchanges to XML in accordance with the present invention are further described with reference to the accompanying drawings in which:

FIG. 1 is a block diagram of exemplary, non-limiting embodiments of a translator component for translating an interchange to XML representation(s) in accordance with the invention;

FIG. 2 is a flow diagram of exemplary, non-limiting processes for configuring the translation of groups of transaction sets to XML representation(s) in accordance with the invention;

FIGS. 3 and 4 are exemplary, non-limiting block diagrams illustrating translation techniques that can be applied to EDI transaction sets translated to XML in accordance with the present invention;

FIG. 5 is an exemplary non-limiting block diagram of alternate translation techniques that can be applied to EDI transaction sets translated to XML in accordance with the present invention;

FIG. 6 displays an exemplary interchange that can be translated according to the configurable options of the translator processes of the invention;

FIG. 7 illustrates individual XML files that are generated according to inflexible translation techniques that provide no options;

FIG. 8 illustrates an exemplary single XML file translated from multiple transaction sets in accordance with a configurable option of the invention;

FIG. 9 illustrates exemplary, non-limiting configuration UI for configuring translation of interchanges to XML representation(s) according to the various embodiments of the invention;

FIG. 10 illustrates exemplary information stored and/or represented on display for a rejected transaction set, such as a transaction set including invalid EDI data;

FIG. 11 is an exemplary block diagram of a representative EDI communications system between a home organization having a server and the trading partners of the home organization;

FIG. 12 is an exemplary block diagram of a representative EDI system including a hub and spoke architecture;

FIG. 13 is an exemplary block diagram representative of an interchange data structure including a plurality of EDI transactions;

FIGS. 14A and 14B illustrate exemplary aspects of a first option enabled by a configuration component of the present invention;

FIG. 15 is a block diagram representing an exemplary non-limiting networked environment in which the present invention may be implemented; and

FIG. 16 is a block diagram representing an exemplary non-limiting computing system or operating environment in which the present invention may be implemented.

### DETAILED DESCRIPTION

### Overview

In consideration of the lack of flexible translation of interchanges to XML in current EDI systems, in various non-limiting embodiments, the invention provides configurable ways for translating interchanges to single or multiple XML representations. In various non-limiting embodiments, the invention enables the translation of an interchange to a single XML document that combines the Transaction Sets of the interchange while preserving the EDI structure as XML. With one configurable option, the single XML document does not include any transaction sets that include any errors. In other non-limiting embodiments, the invention additionally enables the choice to reject all transaction sets of an interchange, if any of the transaction sets includes an error. Any of the options for translating groups of transaction sets of the invention can be configured via a configuration user interface.

### Preserving EDI Structure when Translating to XML

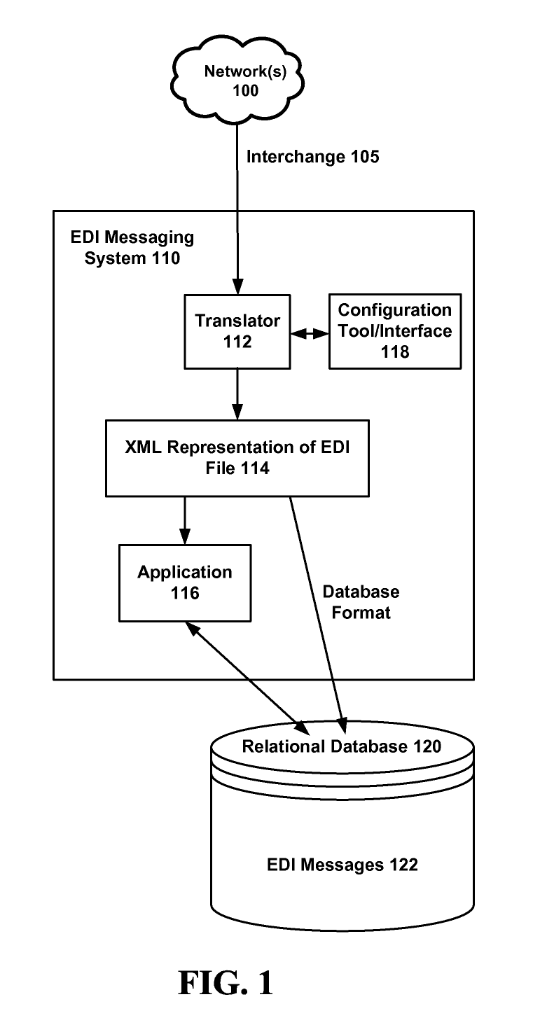

In various non-limiting embodiments, the invention preserves EDI structure as XML while dropping erroneous documents. A typical EDI messaging scenario is depicted in FIG. 1. Via network(s) 100, or retrieved internally, an EDI messaging system 110 may operate to retrieve or receive a group of EDI transaction sets in an interchange file 105 (native EDI flat file format). The interchange 105 is processed on computer systems or components called Translators 112. A common usage of a Translator 112 is to receive the EDI and then, to decode the EDI data to another format, such as XML 114. XML 114 may be further used by an application 116, or stored in relational database 120 with EDI messages 122.

As described in the background, however, available translators merely convert an EDI-Interchange (including multiple transaction sets) into individual transaction set documents. In view of the present inflexibility of such translation to XML described in the background, in various non-limiting embodiments, the invention optionally enables a translator 112 to preserve the entire Interchange as one XML document representing the interchange 105. Further, the invention optionally enables the ability to reject and drop an erroneous transaction set contained in the interchange, and to continue generating the XML representation of the entire interchange while updating the properties, e.g., updating footer level totals. Any of the options are enabled by configuration options provided by exemplary non-limiting configuration user interface.

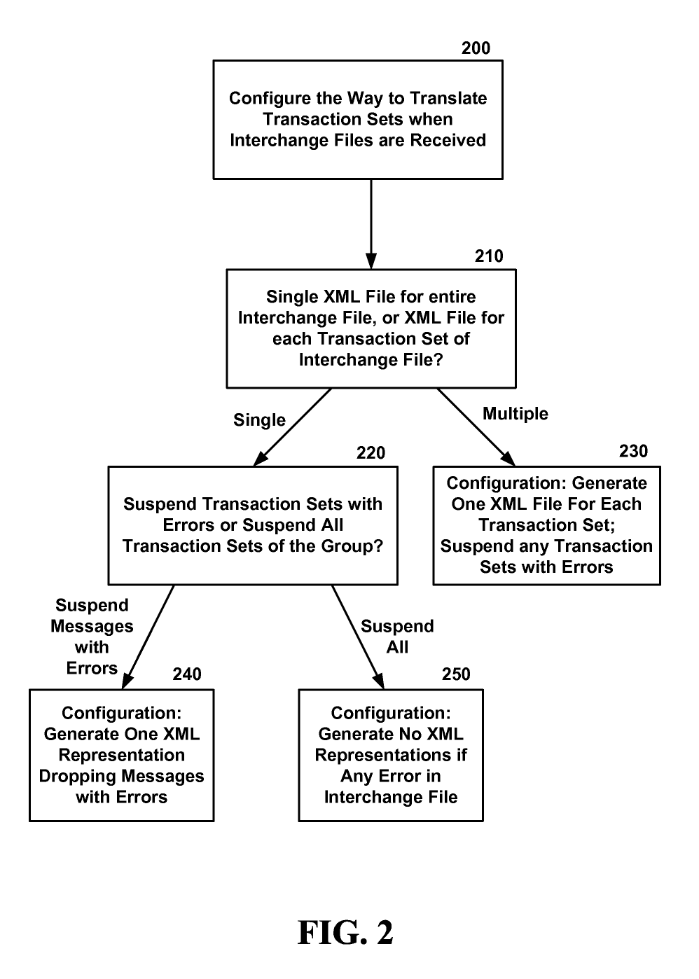

FIG. 2 is a flow diagram illustrating exemplary non-limiting processes for configuring translation of interchange files to XML representation(s) in accordance with the invention. At 200, a user may configure, via a configuration UI or other interface to an EDI messaging system, the way to translate transaction sets when interchange files are received by a translator of the EDI messaging system. At 210, a user may decide whether to generate a single XML representation for the entire interchange file received, or to generate multiple XML representations, one for each transaction set of the interchange. The option to produce a single representation can be advantageous when order of the transaction sets is important. For instance, where breaking up the interchange into individual XML representations for each transaction set would lose the ordering of the transaction sets, it may be beneficial to translate the interchange to a single XML representation that maintains the EDI structure of the interchange.

If the option to produce multiple XML files is selected, then configuration option 230 is enabled, i.e., one XML file is generated for each transaction set, minus any transaction sets with errors. If the option to produce a single XML representation is selected, then a user may additionally choose to configure how to handle errors. For instance, if a user chooses to suspend messages with errors via configuration option 240, then one XML representation is generated for the interchange while dropping any transaction sets with errors.

Option 250 in turn avails the user the option to configure the system to produce no XML if any of the transaction sets of the interchange are invalid, or include bad data. Option 250 might be appropriate where all transaction sets are critical, or lose information when separated.

In various non-limiting embodiments, the invention thus provides the ability to preserve an ‘entire’ interchange per the incoming sequence, the ability to drop erroneous transaction sets and regenerate the interchange while updating footer totals and the ability to control this behavior via configuration options.

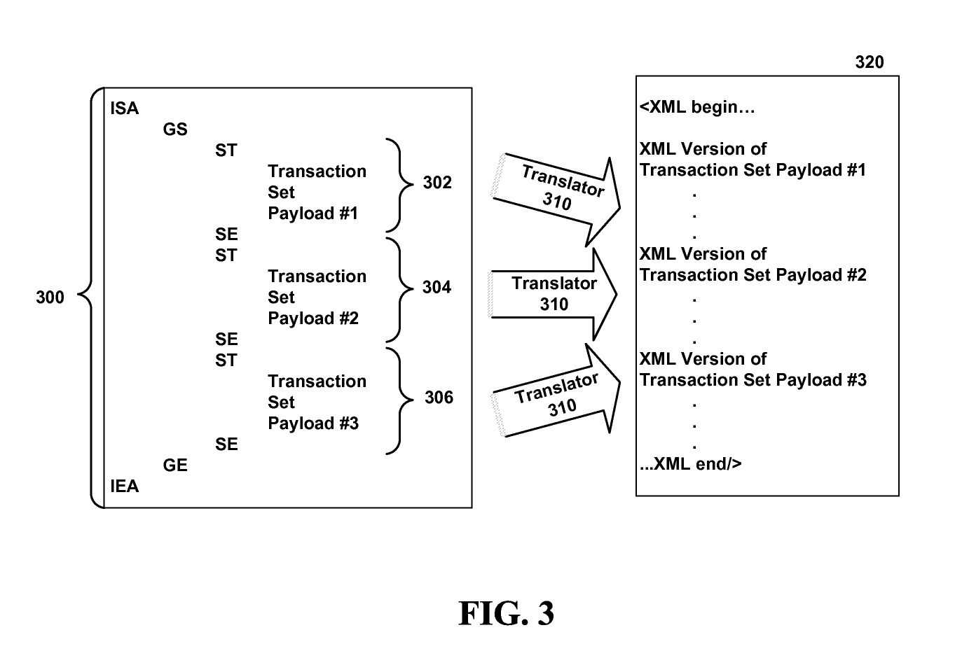

FIG. 3 illustrates exemplary non-limiting translation of an interchange 300 to a single XML file 320 by a translator 310 in accordance with the invention. As shown in FIG. 3, exemplary interchange 300 includes transaction sets 302, 304, and 306, which are combined to form a single XML representation 320 while preserving the EDI structure of interchange 300.

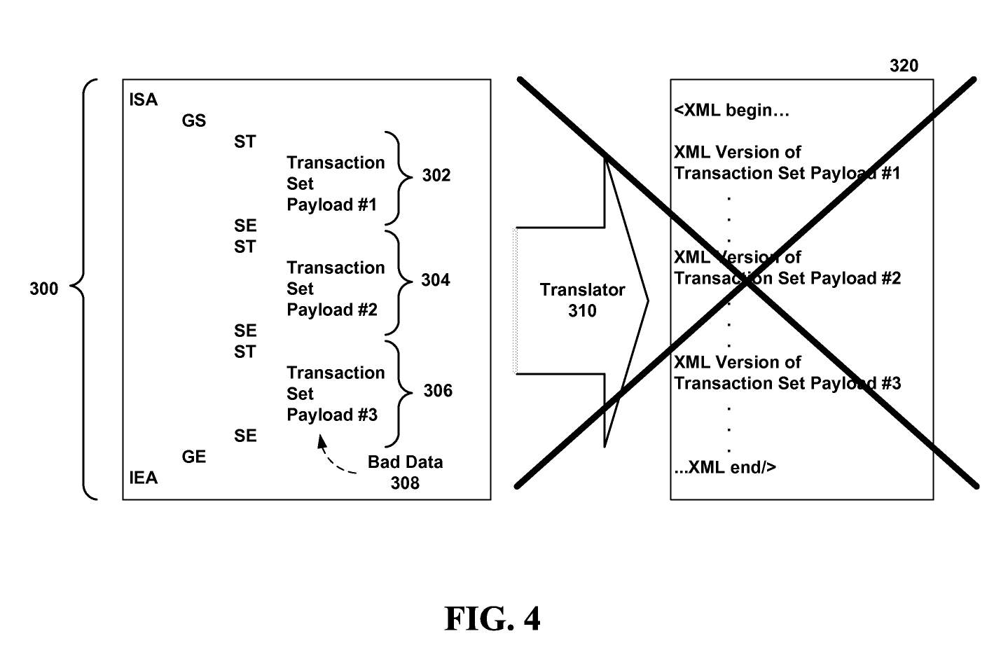

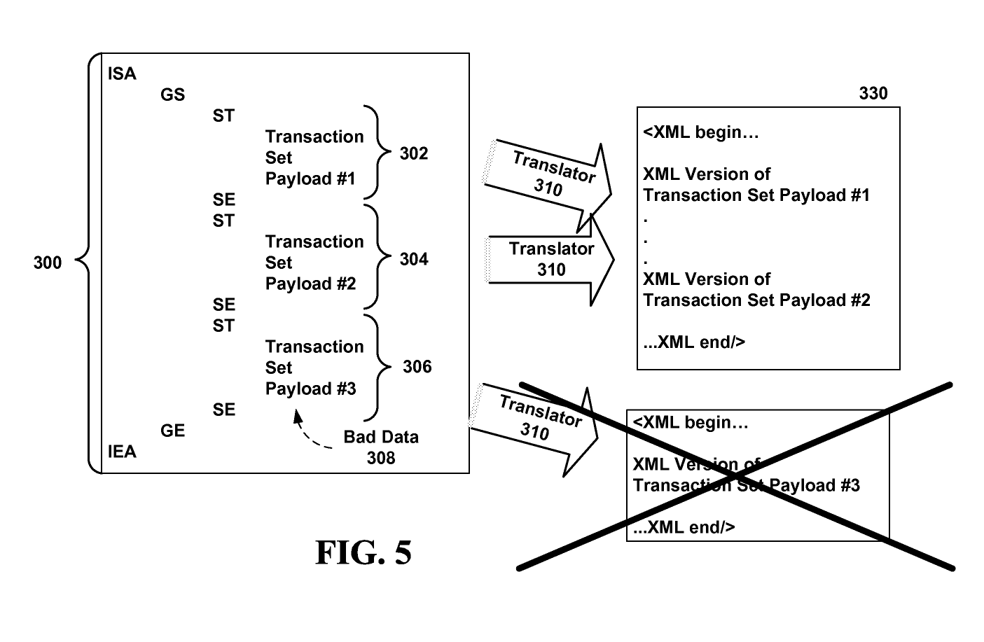

FIGS. 4 and 5 illustrate exemplary configurable options for translating interchange 300 to an XML file according to the invention when interchange 300 includes one or more errors. In one embodiment of the invention, as shown in FIG. 4, when translator 310 translates interchange 300 to the single XML representation in the presence of any error in the transaction sets 302, 304 or 306, such as bad data 308, translator 310 rejects the whole interchange 300, and does not translate to XML representation 310. As mentioned, this might be helpful in an EDI messaging system where it is critical to receive all transaction sets of an interchange 300.

FIG. 5 illustrates further exemplary non-limiting translation of an interchange 300 to a single XML file 330 by a translator 310 in accordance with the invention. In this embodiment of the invention, as shown in FIG. 5, when translator 310 translates interchange 300 to the single XML representation 330 in the presence of any errors, e.g., bad data 308 in transaction set 306, translator 310 combines the transaction sets 302 and 304 into single XML representation 330, while rejecting the bad transaction set 306. Accordingly, the system can continue to generate a single XML representation of the interchange while dynamically discarding transaction sets with errors and adjusting the generation of the single XML representation accordingly, e.g., by adjusting footer totals reflected by the single XML representation.

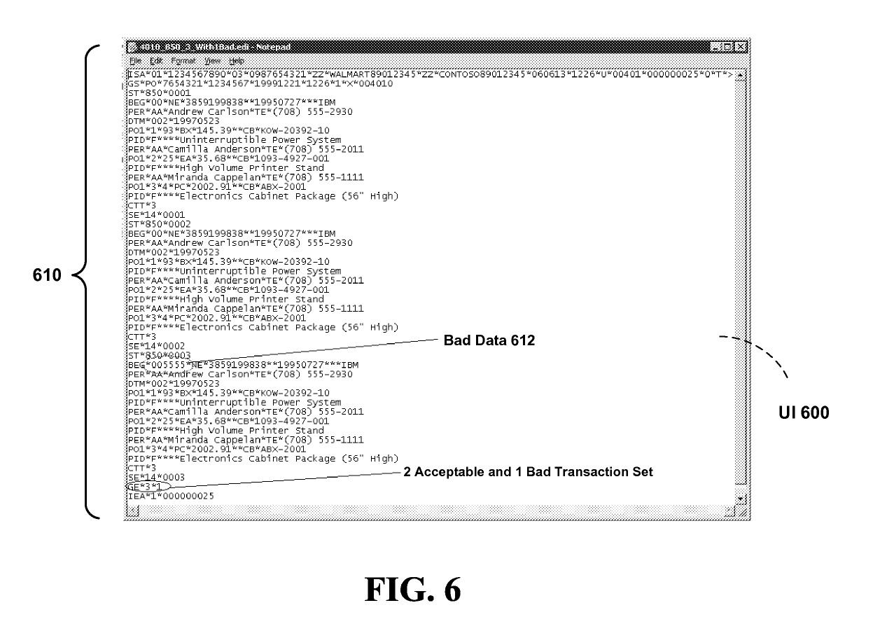

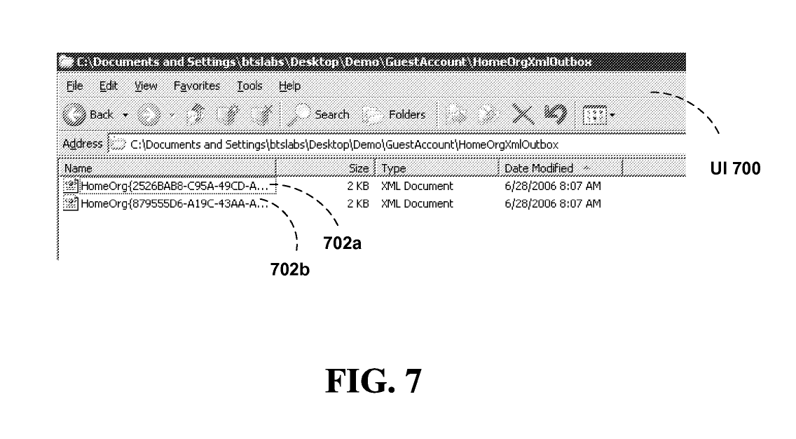

FIG. 6 displays an interchange 610 in exemplary, non-limiting UI 600 having two acceptable and one invalid transaction set including bad data 612 that may be received as an interchange file by an EDI messaging system including a translator in the various configurable embodiments of the invention. As alluded to in the background, existing translators process incoming interchange 610 of FIG. 6 in order to generate two transaction set XML files 700a and 700b as denoted in FIG. 7, while rejecting the bad data without producing a third XML file for the bad transaction set.

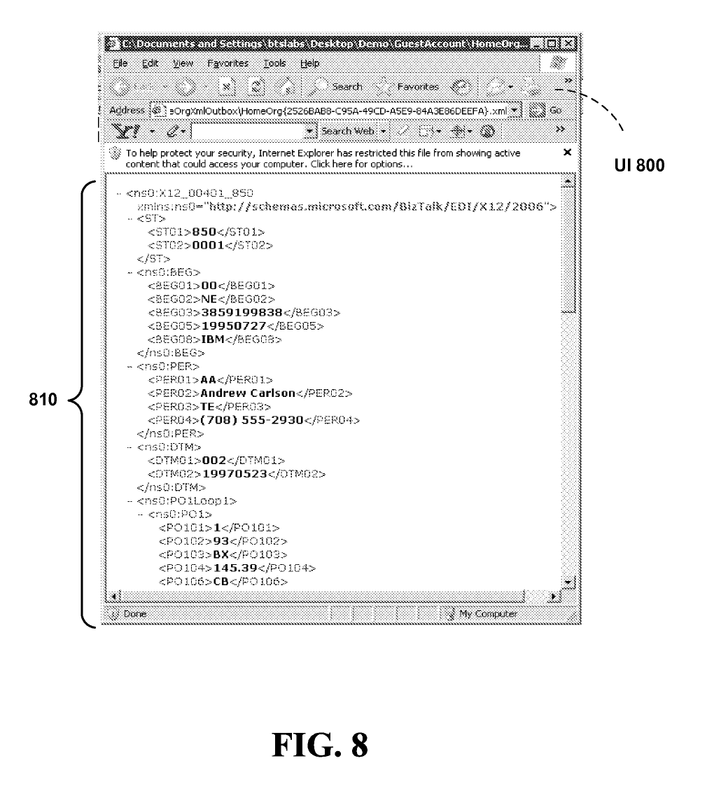

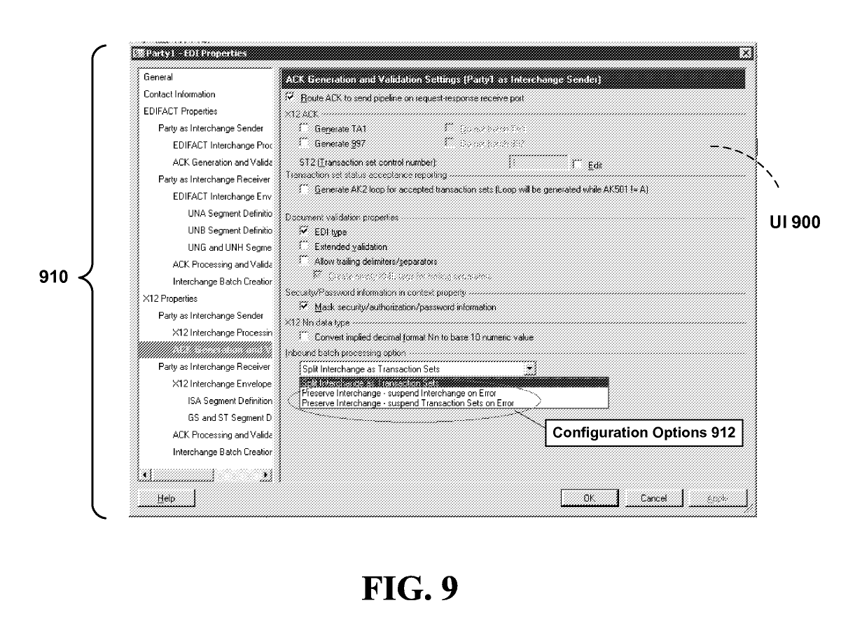

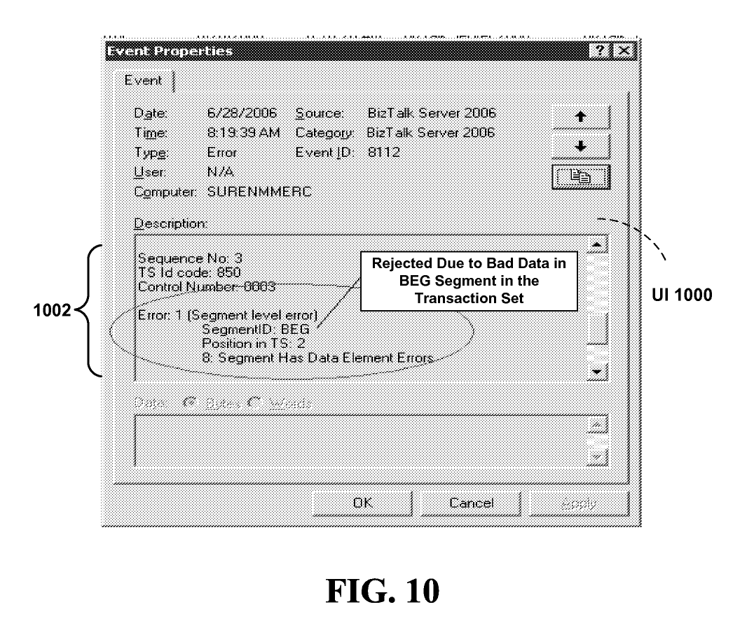

In accordance with the invention, depending on configuration, a transaction set XML file 810 as shown in UI 800 of FIG. 8 is generated for both of the valid transaction sets of interchange 610. As discussed, the invention enables generation of the Interchange XML via configurable settings, as shown via configuration option 912 of a configuration component 910 as represented in UI 900 of FIG. 9. By switching the configuration option, the Interchange will either be rejected in its entirety in the presence of any error or the invention will drop the erroneous transaction set(s) and regenerate the Interchange with the two valid transaction sets, or otherwise continue to generate the Interchange XML without the erroneous transaction set(s).

A corresponding UI 1000 may be displayed to gain more information about why a rejected transaction set, such as the transaction set including the bad data 610, was suspended as part of the translation process. In the example shown, the BEG segment or node is identified as including the bad data, including additional information about the bad data.

### Supplemental Context Regarding EDI Messaging Systems

EDI is the exchange of structured information, by agreed upon messaging standards, from one computer or computer application to another by electronic means with minimal human intervention. Based on approved formatting standards and schemas, EDI is one of the ways businesses exchange computer-to-computer business information. For example, millions of companies around the world transmit and store data associated with business transactions (e.g., purchase orders, shipping/air bills, invoices, or the like) using EDI to conduct commerce.

EDI may thus be defined as computer-to-computer exchange of business information using ‘approved’ formatting standards, referring to specific interchange methods agreed upon by national or international standards bodies for the transfer of business transaction data. One typical application for EDI messaging is the automated purchase of goods and services, though EDI messages are by no means limited to any particular kind of business data. In this regard, millions of companies around the world use EDI to conduct commerce. In raw format, EDI data is transmitted as delimited files (without self describing tags) and therefore the encoding rules enforce very strict formatting rules to ensure the destination application is able to successfully parse and consume the information for down stream processing.

Organizations that send or receive documents from each other are referred to as “trading partners” in EDI terminology. The trading partners agree on the specific information to be transmitted and how it should be used. Service providers provide global platforms (also known as trading grids) to connect and integrate “business partners” around the world. They provide integration platforms that make the exchange of EDI (or XML) documents transparent and easy between diverse constituents. These providers also track and reconcile documents to reduce errors and improve supply chain performance.

EDI translation software provides the interface between the internal system and the common standards and applies to both “inbound” documents and “outbound” documents. Translation software may also utilize other methods or file formats translated to or from EDI.

It can be appreciated by those of skill in the art that the structured information of EDI files can also be represented with the extensible markup language (XML), and vice versa. Despite the use of EDI being somewhat unheralded relative to its counterpart XML, EDI files are still the data format used in a majority of electronic commerce transactions in the world.

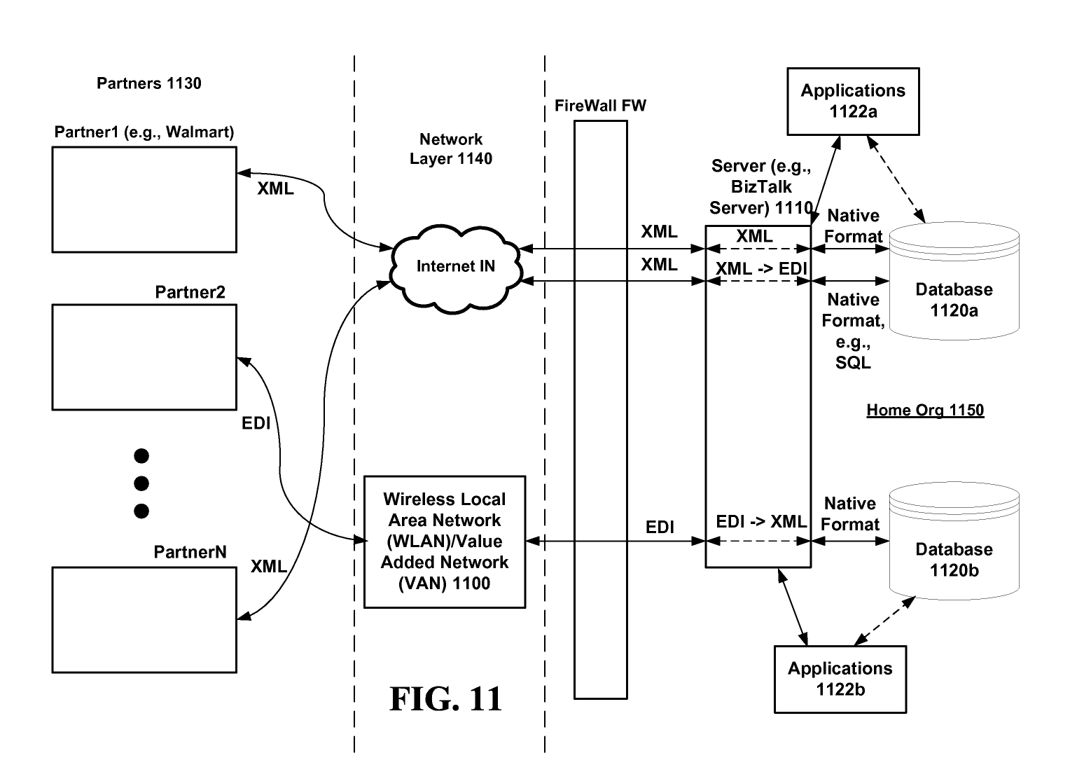

In the exemplary EDI system for a home organization 1150 shown in FIG. 11, typically server software, such as Microsoft's BizTalk Server 1110 can be deployed to interact outside of the home organization 1150 via network layer 1140 and to interface with databases 1120a, 1120b, etc. so that various applications 1122a, 1122b, etc., can interact with the automated storage of business records received by databases 1120a, 1120b, etc. EDI files or XML representations of EDI files can be received via Internet IN, or a wireless local area network (WLAN) or value added network (VAN) 1100 of network layer 1140, e.g., through firewall FW, and such EDI/XML messages can be received from any of a variety of trading partners 1130, i.e., partner1, partner2, . . . , partnerN. Server 1110 can handle any of the necessary conversions and parsing of EDI files or XML representations thereof, and any conversions to or from a native database format, such as SQL.

Typically, when an EDI messages are received, a server receiving the EDI messages can answer in terms of an acknowledgment of receipt of the EDI messages to its trading partner. The server will specify whether the EDI message is invalid according to the schema, and if invalid, will specify why, or the server will specify that the EDI message was accepted, accepted with errors or rejected.

Internet IN has enabled EDI transactions to be transmitted between trading partners in an even more efficient manner. Internet IN provides business and government agencies with an environment that is open, fast, cost effective, and widely accepted and used.

VAN 1100 is a mechanism that facilitates the transfer of electronic data between trading partners. A VAN 1100 can be thought of as a post office, or a dedicated pipe, which allows an entity to send EDI formatted data to one of their trading partners at any time. The VAN 1100 will hold the file of transmitted transactions until the trading partner to whom it is addressed retrieves it at a later time.

The EDI standards were designed to be independent of lower level technologies and can be transmitted using Internet protocols, such as the file transfer protocol (FTP), telnet and email, as well as private networks, such as value-added networks (VANs). EDI documents contain the same data that would normally be found in a paper document used for the same organizational function. For example, an EDI ship-from-warehouse order might be used by a manufacturer to tell a warehouse to ship product(s) to a retailer. It typically has a ship to address, bill to address, a list of product numbers (e.g., a UPC code) and quantities. It may also have other information if the parties agree to include it. However, EDI is not confined to just business data directly related to trade, rather but encompasses all fields such as medicine (patient records, laboratory results, etc.), transport (container and modal information, etc.), engineering and construction, etc., i.e., anywhere a first entity may wish to automate the exchange of data with another entity.

In a typical EDI transaction model, a large business entity or an EDI integration broker trades with numerous partners and has the technical capability to handle numerous EDI transaction data in various EDI formats and schemas. These entities, also known as “hubs,” transact with one or more suppliers, also known as “spokes.” Each of the spokes typically is a relatively small business entity that is only capable of dealing with one hub.

Before the spokes attempt to initiate transactions via EDI with the hub, the hub typically transmits various EDI schemas to the spokes so that the spokes can properly format the EDI transactions according to the EDI schemas.

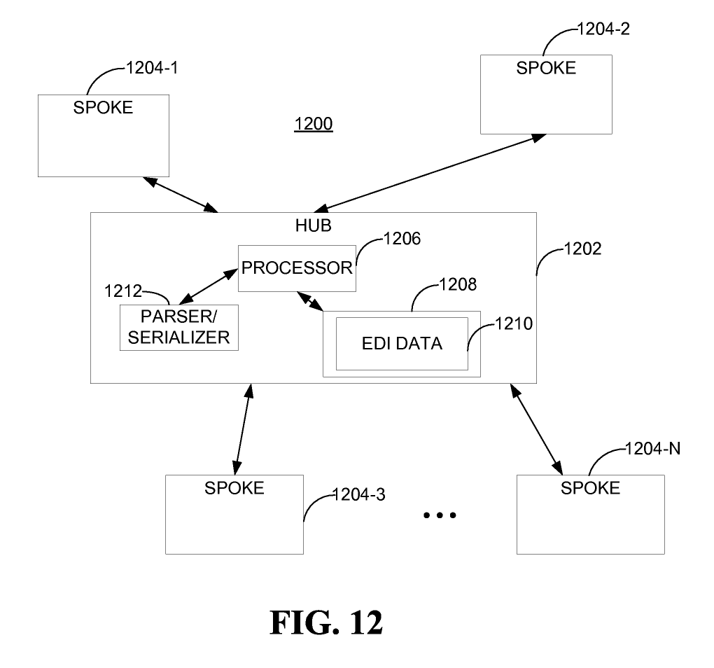

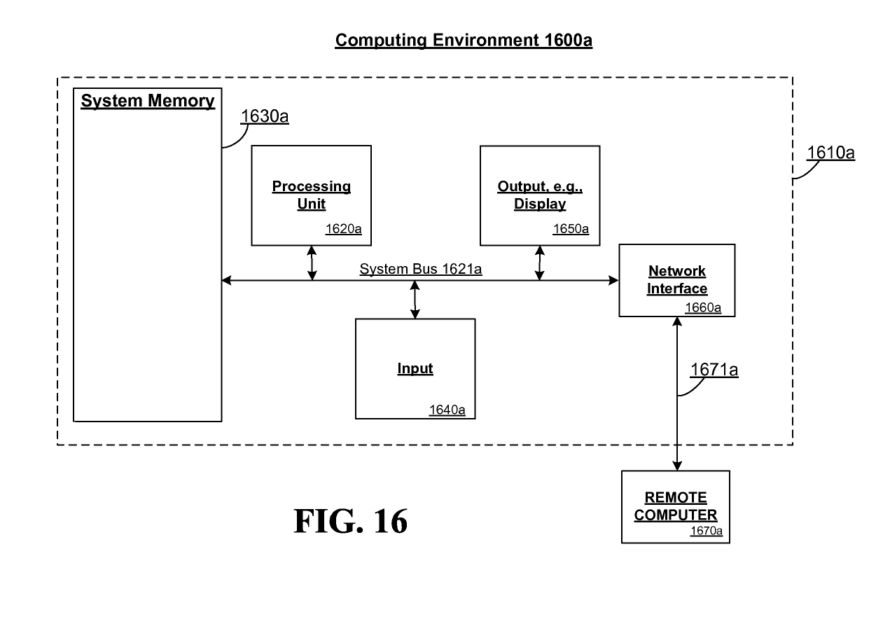

FIG. 12 is a block diagram illustrating a system for conducting EDI transactions according to exemplary non-limiting embodiments of the invention. A system 1200 is illustrated for conducting EDI transactions. System 1200 includes a hub 1202 linked to and communicating with one or more spokes (e.g., spokes 1204-1, 1204-2, 1204-3, . . . , 1204-N). In one embodiment, the hub 1202 includes a server computer or a computing device serving one or more processors (e.g., processor 1206) or processing units for executing computer-executable instructions for serving the spokes 1204. In one example, the spokes 1204 include a computing device having one or more components included in or coupled with a computer 1230, as shown in FIG. 16.

In one example, the hub 1202 also includes a memory area 1208 for storing one or more EDI schemas, such as an EDI schema 1210. Initially, the hub 1202 and the spokes 1204-1, 1204-2, 1204-3, . . . , 1204-N establish agreements as to the EDI formats or standards to be used for transmitting transaction data therebetween. Once the parties determine the particular EDI formats or standards to use, the hub 1202 selects the appropriate EDI schemas to be transmitted to the spokes 1204-1, 1204-2, 1204-3, . . . , 1204-N. In another example, the hub 1202 may choose to select all EDI schemas for all types of transactions, such as purchase orders, bills of lading, invoices, payrolls, or the like, to the spokes 1204-1, 1204-2, 1204-3, . . . , 1204N.

Although the communications between the hub 1202 and the spokes 1204-1, 1204-2, 1204-3, . . . , 1204-N can be a private or public communications network, a wired or wireless network, the spokes 1204-1, 1204-2, 1204-3, . . . , 1204-N typically lack the hardware resources to handle large amount of EDI schemas sent from the hub 1202. In addition, the type and bandwidth of computing network communications for the spokes 1204-1, 1204-2, 1204-3, . . . , 1204-N are not equipped to handle such demand imposed by the thousands of EDI schemas, which can reach several Gigabytes in data size.

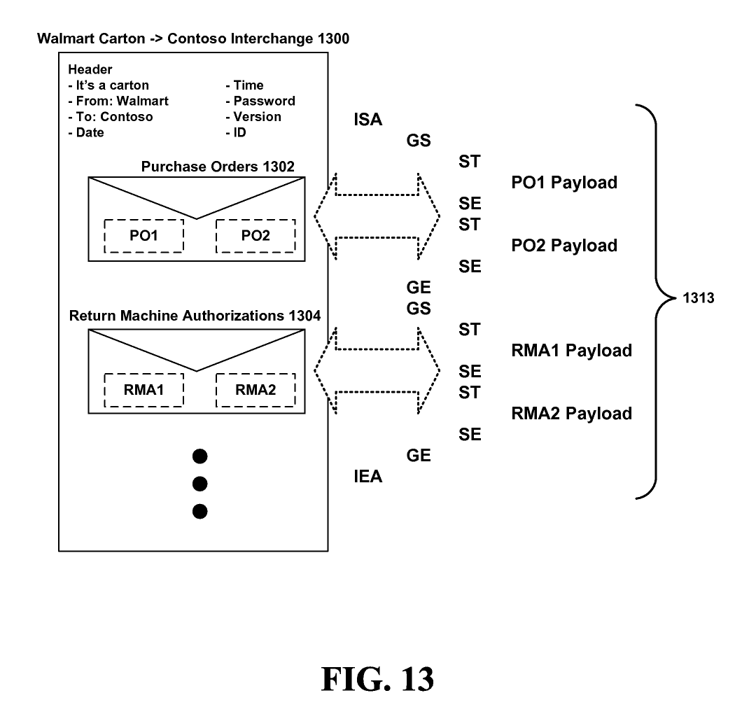

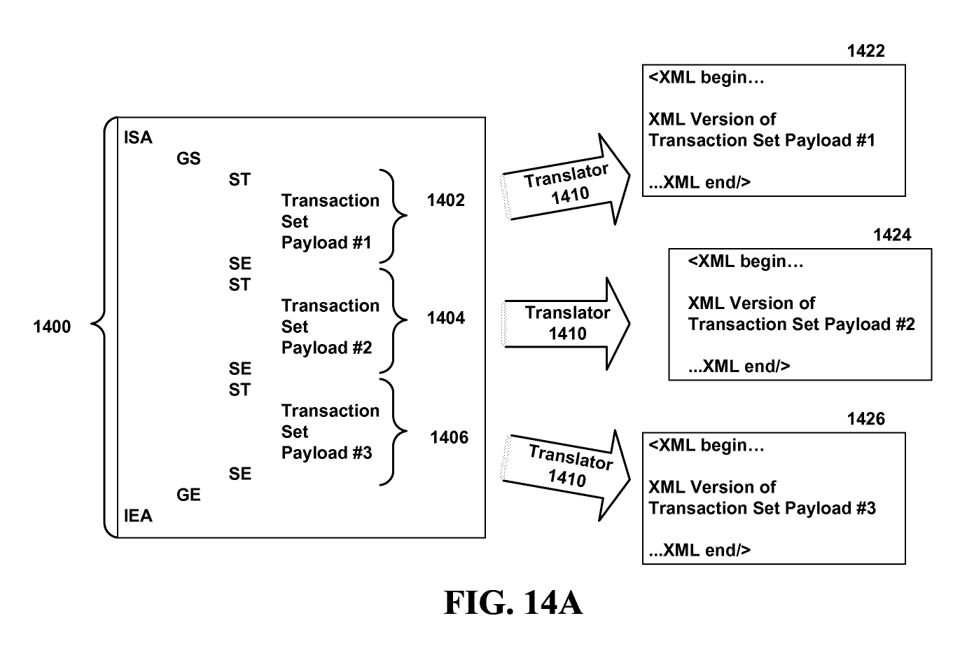

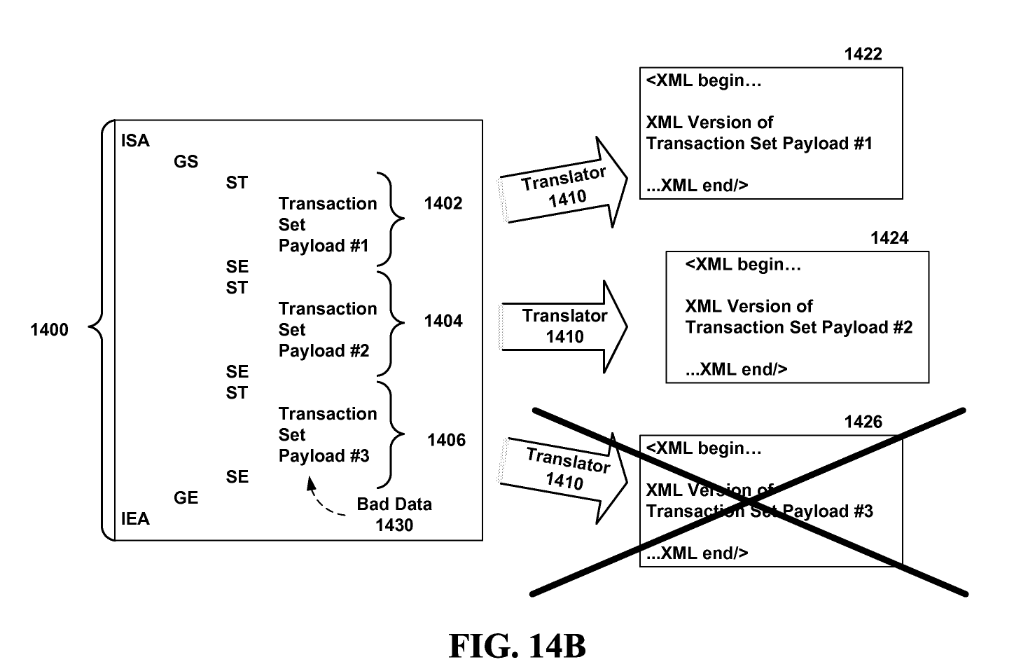

FIG. 13 in turn illustrates that an organization can generate an interchange 1300—a sort of carton for EDI messages—which includes a plurality of EDI messages. Interchange 1300 typically includes a header which includes a type of document, from whom the document originated, to whom the document is addressed, the date, the time, any password information, version information, identification information, and the like. Then the interchange 1300 lists a series of purchase orders 1302 and return machine authorizations (RMAs) 1304, conceptually shown as envelopes in the carton. In turn, each envelope conceptually represents one or more individual EDI files, or messages. For instance, purchase orders 1302 include individual purchase orders PO1 and PO2, and RMAs 1304 include RMAs RMA1 and RMA2, and so on.

In turn, there is a flat file native EDI format that corresponds to this conceptual relationship between carton->envelopes->messages. As illustrated by shell 1313 corresponding to the conceptual representation, the ISA<->IEA indent level represents the beginning and end of the interchange (carton). The GS and GE indent levels represent the beginning and end of any envelopes within the carton, and the ST and SE indent levels represent the beginning and end of any messages within an envelope, i.e., inbetween any ST and SE will be an individual message payload, such as PO1 Payload, PO2 Payload, RMA1 Payload and RMA2 Payload.

There are several advantages of using EDI all of which provide distinct benefits to the user. One of the most notable benefits to using EDI is the time-saving capability it provides. By eliminating the process of distributing hard copies of information throughout the company, easy access to electronic data simplifies inter-department communication. Also, another time-savings advantage is the ability to track the origin of all information therefore significantly reducing time spent on corresponding with the source of the information.

Another benefit for the user of this information system is the ultimate savings in costs for an organization. Although the initial set-up costs may seem high, the overall savings received in the long run ensures its value. For any business, regardless of its size, hard-copy print outs and document shipping costs add up. EDI allows for a paper-less exchange of information reducing handling costs and worker productivity that is involved with the organization of paper documents.

EDI has another strong advantage over paper-based information exchange, which has to do with accuracy of information. When the information is already stored electronically, it speeds up an organizations ability to check for accuracy and make any necessary corrections as the data is already input to the system. Also, unlike paper-based methods, EDI allows for the ability to send and receive information at any time thereby tremendously improving an organizations ability to communicate quickly and efficiently.

A disadvantage of using EDI involves the initial set-up. The preliminary expenses and time that arise from the implementation, customization and training can be costly. However, as EDI systems continue to improve, such as by using the batching membership evaluation techniques of the invention, such disadvantage is disappearing as ease of use increase.

### EDIFACT And X12 Standards for EDI Documents

There are two major sets of EDI standards which can be used to generate and receive/process EDI messages: the United Nations Electronic Data Interchange for Administration, Commerce and Transport, which is a translation of UN/EDIFACT (“EDIFACT”) and the American National Standards Institute's (ANSI) Accredited Standards Committee (ASC) X12 (“X12”). Both used worldwide, X12 tends to be more popular in North America than EDIFACT. These standards prescribe the formats, character sets, and data elements used in the exchange of documents and forms, such as invoices and purchase orders, e.g., purchase orders are called “ORDERS” in EDIFACT and “850s” in X12.

Whichever selected, the standard dictates which pieces of information are mandatory for a particular document, which pieces are optional and gives the rules for the structure of the document. In this regard, with optional pieces, two EDI documents can follow the same standard and contain different sets of information. For example, a food company might indicate a particular product expiration date while a clothing manufacturer might choose to send color and size information.

For illustrative purposes only, the following is an example EDIFACT message, for instance, that might be used to answer to a product availability request:

UNB+IATB:1+6XPPC+LHPPC+VV40101:0VV50+1’
UNH+1+PAORES:VV3:1:IA’
MSG+1:45’
IFT+3+?*XYZCOMPANY AVAILABILITY?*’
ERC+A7V:1:AMD’
IFT+3+NO MORE FLIGHTS'
ODI’
TVL+2404VV3:1000::1220+FRA+JFK+DL+400+C’
PDI++C:3+Y::3+F::1’
APD+74C:0:::6++++++6X’
TVL+2404VV3:1740::2030+JFK+MIA+DL+081+C′
PDI++C:4’
APD+EM2:0:1630::6+++++++DA’
UNT+13+1’
UNZ+1+1’
wherein the following symbols have the following meanings:
‘ is a segment terminator;
+ is a data element separator;
: is a component data element separator;
* is a repetition separator; and
? is a release character.

To explain the information contained in some of the above segments, the segment of the above exemplary EDI file designated by “UNH+1+PAORES:VV3:1:IA′” is the header segment. A header segment is required at the start of every EDI message. With this particular file segment, the message name and version is specified as PAORES VV3 revision 1 and it was defined by the organization IATA. The segment of the above exemplary EDI file designated by “IFT+3+NO MORE FLIGHTS′” is an ‘Interactive Free Text’ segment containing the text ‘NO MORE FLIGHTS.’ The segment of the above exemplary EDI file designated by “UNT+13+1′” is the tail segment, whereby it is indicated that the message sent contains 13 segments.

EDIFACT files have a hierarchical structure. The top level element is referred to a message. A message is a sequence of groups and segments. A group or segment can be mandatory (M) or conditional (C) and can be specified to repeat, for example CVVVV would indicate between 0 and VVVV repetitions of a segment or group, whereas MVVVV would mean between 1 and VVVV repetitions.

A group, like a message, is a sequence of segments or groups. The first segment/group beneath a group must be mandatory. If the logic of the situation demands it is conditional, then the group itself should be made conditional instead.

In exemplary practice, where the X12 standard is used, X12 schemas use the following format:

X12 Schemas=X12_{Version}_{—{TsId},}

which indicates that:

1) all X12 schemas have a root node name that starts with X12;

2) “Version” represents the version information of the document, and it is a dynamic piece of information which is configuration or instance driven; and

3) “TsId” stands for “transaction ID” of the document being processed and is read from the input instance.

In exemplary practice, where the EDIFACT standard is used, EDIFACT schemas use the following format:

EDIFACT Schemas=Efact_{Version}_{Tsid},

which indicates that:

1) all EDIFACT schemas have root node name that starts with Efact;

2) “Version” represents the version information of the document, and it is a dynamic piece of information which is configuration or instance driven; and

3) “TsId” stands for “transaction ID” of the document being processed and is read from the input instance.

Accordingly, the root node name can be used to distinguish between X12 and EDIFACT representations of structured information.

### Exemplary Networked and Distributed Environments

One of ordinary skill in the art can appreciate that the invention can be implemented in connection with any computer or other client or server device, which can be deployed as part of a computer network, or in a distributed computing environment, connected to any kind of data store. In this regard, the present invention pertains to any computer system or environment having any number of memory or storage units, and any number of applications and processes occurring across any number of storage units or volumes, which may be used in connection with processes for translating EDI transaction sets to XML in accordance with the present invention. The present invention may apply to an environment with server computers and client computers deployed in a network environment or a distributed computing environment, having remote or local storage. The present invention may also be applied to standalone computing devices, having programming language functionality, interpretation and execution capabilities for generating, receiving and transmitting information in connection with remote or local services and processes.

Distributed computing provides sharing of computer resources and services by exchange between computing devices and systems. These resources and services include the exchange of information, cache storage and disk storage for objects, such as files. Distributed computing takes advantage of network connectivity, allowing clients to leverage their collective power to benefit the entire enterprise. In this regard, a variety of devices may have applications, objects or resources that may implicate the systems and methods for translating EDI transaction sets to XML in accordance with the invention.

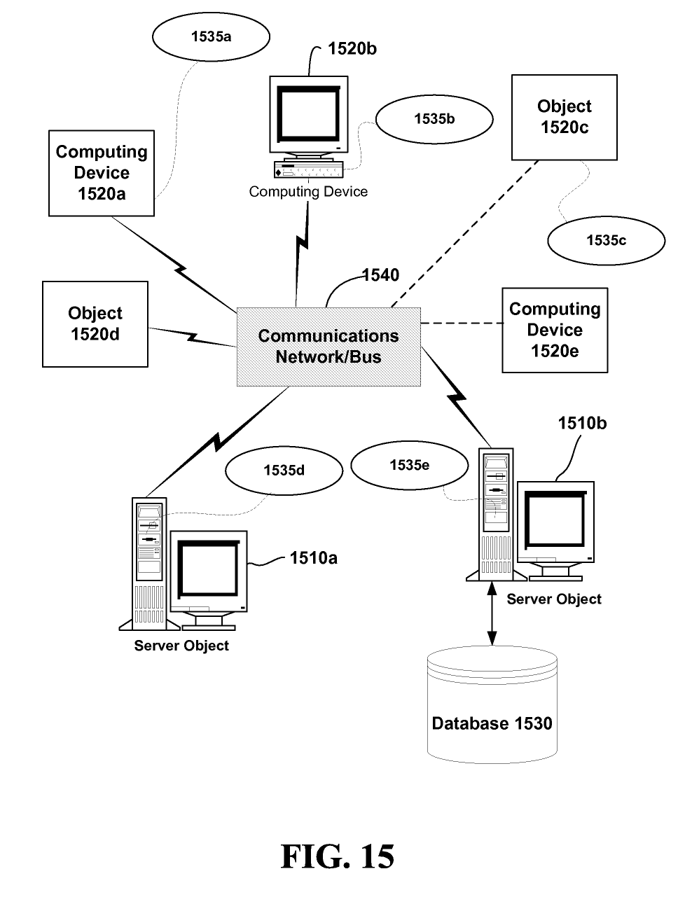

FIG. 15 provides a schematic diagram of an exemplary networked or distributed computing environment. The distributed computing environment comprises computing objects 1510a, 1510b, etc. and computing objects or devices 1520a, 1520b, 1520c, 1520d, 1520e, etc. These objects may comprise programs, methods, data stores, programmable logic, etc. The objects may comprise portions of the same or different devices such as PDAs, audio/video devices, MP3 players, personal computers, etc. Each object can communicate with another object by way of the communications network 1540. This network may itself comprise other computing objects and computing devices that provide services to the system of FIG. 15, and may itself represent multiple interconnected networks. In accordance with an aspect of the invention, each object 1510a, 1510b, etc. or 1520a, 1520b, 1520c, 1520d, 1520e, etc. may contain an application that might make use of an API, or other object, software, firmware and/or hardware, suitable for use with the systems and methods for translating EDI transaction sets to XML in accordance with the invention.

It can also be appreciated that an object, such as 1520c, may be hosted on another computing device 1510a, 1510b, etc. or 1520a, 1520b, 1520c, 1520d, 1520e, etc. Thus, although the physical environment depicted may show the connected devices as computers, such illustration is merely exemplary and the physical environment may alternatively be depicted or described comprising various digital devices such as PDAs, televisions, MP3 players, etc., any of which may employ a variety of wired and wireless services, software objects such as interfaces, COM objects, and the like.

There are a variety of systems, components, and network configurations that support distributed computing environments. For example, computing systems may be connected together by wired or wireless systems, by local networks or widely distributed networks. Currently, many of the networks are coupled to the Internet, which provides an infrastructure for widely distributed computing and encompasses many different networks. Any of the infrastructures may be used for exemplary communications made incident to translating EDI transaction sets to XML according to the present invention.

The Internet commonly refers to the collection of networks and gateways that utilize the Transmission Control Protocol/Internet Protocol (TCP/IP) suite of protocols, which are well-known in the art of computer networking. The Internet can be described as a system of geographically distributed remote computer networks interconnected by computers executing networking protocols that allow users to interact and share information over network(s). Because of such wide-spread information sharing, remote networks such as the Internet have thus far generally evolved into an open system with which developers can design software applications for performing specialized operations or services, essentially without restriction.

Thus, the network infrastructure enables a host of network topologies such as client/server, peer-to-peer, or hybrid architectures. The “client” is a member of a class or group that uses the services of another class or group to which it is not related. Thus, in computing, a client is a process, i.e., roughly a set of instructions or tasks, that requests a service provided by another program. The client process utilizes the requested service without having to “know” any working details about the other program or the service itself. In a client/server architecture, particularly a networked system, a client is usually a computer that accesses shared network resources provided by another computer, e.g., a server. In the illustration of FIG. 15, as an example, computers 1520a, 1520b, 1520c, 1520d, 1520e, etc. can be thought of as clients and computers 1510a, 1510b, etc. can be thought of as servers where servers 1510a, 1510b, etc. maintain the data that is then replicated to client computers 1520a, 1520b, 1520c, 1520d, 1520e, etc., although any computer can be considered a client, a server, or both, depending on the circumstances. Any of these computing devices may be processing data or requesting services or tasks that may implicate the translation of EDI transaction sets to XML in accordance with the invention.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the techniques for translating EDI transaction sets to XML of the invention may be distributed across multiple computing devices or objects.

Client(s) and server(s) communicate with one another utilizing the functionality provided by protocol layer(s). For example, HyperText Transfer Protocol (HTTP) is a common protocol that is used in conjunction with the World Wide Web (WWW), or “the Web.” Typically, a computer network address such as an Internet Protocol (IP) address or other reference such as a Universal Resource Locator (URL) can be used to identify the server or client computers to each other. The network address can be referred to as a URL address. Communication can be provided over a communications medium, e.g., client(s) and server(s) may be coupled to one another via TCP/IP connection(s) for high-capacity communication.

Thus, FIG. 15 illustrates an exemplary networked or distributed environment, with server(s) in communication with client computer (s) via a network/bus, in which the present invention may be employed. In more detail, a number of servers 1510a, 1510b, etc. are interconnected via a communications network/bus 1540, which may be a LAN, WAN, intranet, GSM network, the Internet, etc., with a number of client or remote computing devices 1520a, 1520b, 1520c, 1520d, 1520e, etc., such as a portable computer, handheld computer, thin client, networked appliance, or other device, such as a VCR, TV, oven, light, heater and the like in accordance with the present invention. It is thus contemplated that the present invention may apply to any computing device in connection with which it is desirable to translate groups of EDI transaction sets to XML.

In a network environment in which the communications network/bus 1540 is the Internet, for example, the servers 1510a, 1510b, etc. can be Web servers with which the clients 1520a, 1520b, 1520c, 1520d, 1520e, etc. communicate via any of a number of known protocols such as HTTP. Servers 1510a, 1510b, etc. may also serve as clients 1520a, 1520b, 1520c, 1520d, 1520e, etc., as may be characteristic of a distributed computing environment.

As mentioned, communications may be wired or wireless, or a combination, where appropriate. Client devices 1520a, 1520b, 1520c, 1520d, 1520e, etc. may or may not communicate via communications network/bus 14, and may have independent communications associated therewith. For example, in the case of a TV or VCR, there may or may not be a networked aspect to the control thereof. Each client computer 1520a, 1520b, 1520c, 1520d, 1520e, etc. and server computer 1510a, 1510b, etc. may be equipped with various application program modules or objects 135a, 135b, 135c, etc. and with connections or access to various types of storage elements or objects, across which files or data streams may be stored or to which portion(s) of files or data streams may be downloaded, transmitted or migrated. Any one or more of computers 1510a, 1510b, 1520a, 1520b, 1520c, 1520d, 1520e, etc. may be responsible for the maintenance and updating of a database 1530 or other storage element, such as a database or memory 1530 for storing data processed or saved according to the invention. Thus, the present invention can be utilized in a computer network environment having client computers 1520a, 1520b, 1520c, 1520d, 1520e, etc. that can access and interact with a computer network/bus 1540 and server computers 1510a, 1510b, etc. that may interact with client computers 1520a, 1520b, 1520c, 1520d, 1520e, etc. and other like devices, and databases 1530.

### Exemplary Computing Device

As mentioned, the invention applies to any device wherein it may be desirable to translate EDI transaction sets to XML. It should be understood, therefore, that handheld, portable and other computing devices and computing objects of all kinds are contemplated for use in connection with the present invention, i.e., anywhere that a device may translate EDI transaction sets to XML or otherwise receive, process or store EDI data or corresponding XML representations. Accordingly, the below general purpose remote computer described below in FIG. 16 is but one example, and the present invention may be implemented with any client having network/bus interoperability and interaction. Thus, the present invention may be implemented in an environment of networked hosted services in which very little or minimal client resources are implicated, e.g., a networked environment in which the client device serves merely as an interface to the network/bus, such as an object placed in an appliance.

Although not required, the invention can partly be implemented via an operating system, for use by a developer of services for a device or object, and/or included within application software that operates in connection with the component(s) of the invention. Software may be described in the general context of computer-executable instructions, such as program modules, being executed by one or more computers, such as client workstations, servers or other devices. Those skilled in the art will appreciate that the invention may be practiced with other computer system configurations and protocols.

FIG. 16 thus illustrates an example of a suitable computing system environment 1600a in which the invention may be implemented, although as made clear above, the computing system environment 1600a is only one example of a suitable computing environment for a media device and is not intended to suggest any limitation as to the scope of use or functionality of the invention. Neither should the computing environment 1600a be interpreted as having any dependency or requirement relating to any one or combination of components illustrated in the exemplary operating environment 1600a.

With reference to FIG. 16, an exemplary remote device for implementing the invention includes a general purpose computing device in the form of a computer 1610a. Components of computer 1610a may include, but are not limited to, a processing unit 1620a, a system memory 1630a, and a system bus 1621a that couples various system components including the system memory to the processing unit 1620a. The system bus 1621a may be any of several types of bus structures including a memory bus or memory controller, a peripheral bus, and a local bus using any of a variety of bus architectures.

Computer 1610a typically includes a variety of computer readable media. Computer readable media can be any available media that can be accessed by computer 1610a. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 1610a. Communication media typically embodies computer readable instructions, data structures, program modules or other data in a modulated data signal such as a carrier wave or other transport mechanism and includes any information delivery media.

The system memory 1630a may include computer storage media in the form of volatile and/or nonvolatile memory such as read only memory (ROM) and/or random access memory (RAM). A basic input/output system (BIOS), containing the basic routines that help to transfer information between elements within computer 1610a, such as during start-up, may be stored in memory 1630a. Memory 1630a typically also contains data and/or program modules that are immediately accessible to and/or presently being operated on by processing unit 1620a. By way of example, and not limitation, memory 1630a may also include an operating system, application programs, other program modules, and program data.

The computer 1610a may also include other removable/non-removable, volatile/nonvolatile computer storage media. For example, computer 1610a could include a hard disk drive that reads from or writes to non-removable, nonvolatile magnetic media, a magnetic disk drive that reads from or writes to a removable, nonvolatile magnetic disk, and/or an optical disk drive that reads from or writes to a removable, nonvolatile optical disk, such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM and the like. A hard disk drive is typically connected to the system bus 1621a through a non-removable memory interface such as an interface, and a magnetic disk drive or optical disk drive is typically connected to the system bus 1621a by a removable memory interface, such as an interface.

A user may enter commands and information into the computer 1610a through input devices such as a keyboard and pointing device, commonly referred to as a mouse, trackball or touch pad. Other input devices may include a microphone, joystick, game pad, satellite dish, scanner, or the like. These and other input devices are often connected to the processing unit 1620a through user input 1640a and associated interface(s) that are coupled to the system bus 1621a, but may be connected by other interface and bus structures, such as a parallel port, game port or a universal serial bus (USB). A graphics subsystem may also be connected to the system bus 1621a. A monitor or other type of display device is also connected to the system bus 1621a via an interface, such as output interface 1650a, which may in turn communicate with video memory. In addition to a monitor, computers may also include other peripheral output devices such as speakers and a printer, which may be connected through output interface 1650a.

The computer 1610a may operate in a networked or distributed environment using logical connections to one or more other remote computers, such as remote computer 1670a, which may in turn have media capabilities different from device 1610a. The remote computer 1670a may be a personal computer, a server, a router, a network PC, a peer device or other common network node, or any other remote media consumption or transmission device, and may include any or all of the elements described above relative to the computer 1610a. The logical connections depicted in FIG. 16 include a network 1671a, such local area network (LAN) or a wide area network (WAN), but may also include other networks/buses. Such networking environments are commonplace in homes, offices, enterprise-wide computer networks, intranets and the Internet.

When used in a LAN networking environment, the computer 1610a is connected to the LAN 1671a through a network interface or adapter. When used in a WAN networking environment, the computer 1610a typically includes a communications component, such as a modem, or other means for establishing communications over the WAN, such as the Internet. A communications component, such as a modem, which may be internal or external, may be connected to the system bus 1621a via the user input interface of input 1640a, or other appropriate mechanism. In a networked environment, program modules depicted relative to the computer 1610a, or portions thereof, may be stored in a remote memory storage device. It will be appreciated that the network connections shown and described are exemplary and other means of establishing a communications link between the computers may be used.

### Exemplary Distributed Computing Architectures

Various distributed computing frameworks have been and are being developed in light of the convergence of personal computing and the Internet. Individuals and business users alike are provided with a seamlessly interoperable and Web-enabled interface for applications and computing devices, making computing activities increasingly Web browser or network-oriented.

For example, MICROSOFT®'s managed code platform, i.e., .NET, includes servers, building-block services, such as Web-based data storage and downloadable device software. Generally speaking, the .NET platform provides (1) the ability to make the entire range of computing devices work together and to have user information automatically updated and synchronized on all of them, (2) increased interactive capability for Web pages, enabled by greater use of XML rather than HTML, (3) online services that feature customized access and delivery of products and services to the user from a central starting point for the management of various applications, such as e-mail, for example, or software, such as Office .NET, (4) centralized data storage, which increases efficiency and ease of access to information, as well as synchronization of information among users and devices, (5) the ability to integrate various communications media, such as e-mail, faxes, and telephones, (6) for developers, the ability to create reusable modules, thereby increasing productivity and reducing the number of programming errors and (7) many other cross-platform and language integration features as well.

While some exemplary embodiments herein are described in connection with software, such as an application programming interface (API), residing on a computing device, one or more portions of the invention may also be implemented via an operating system, or a “middle man” object, a control object, hardware, firmware, intermediate language instructions or objects, etc., such that the methods for translating EDI transaction sets to XML in accordance with the invention may be included in, supported in or accessed via all of the languages and services enabled by managed code, such as .NET code, and in other distributed computing frameworks as well.

There are multiple ways of implementing the present invention, e.g., an appropriate API, tool kit, driver code, operating system, control, standalone or downloadable software object, etc. which enables applications and services to use the systems and methods for translating EDI transaction sets to XML of the invention. The invention contemplates the use of the invention from the standpoint of an API (or other software object), as well as from a software or hardware object that receives and/or translates EDI transaction sets to XML in accordance with the invention. Thus, various implementations of the invention described herein may have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

As mentioned above, while exemplary embodiments of the present invention have been described in connection with various computing devices and network architectures, the underlying concepts may be applied to any computing device or system in which it is desirable to translate EDI transaction sets to XML. For instance, a translator provided in accordance with any of the embodiments of the invention may be applied to the operating system of a computing device, provided as a separate object on the device, as part of another object, as a reusable control, as a downloadable object from a server, as a “middle man” between a device or object and the network, as a distributed object, as hardware, in memory, a combination of any of the foregoing, etc. While exemplary programming languages, names and examples are chosen herein as representative of various choices, these languages, names and examples are not intended to be limiting. One of ordinary skill in the art will appreciate that there are numerous ways of providing object code and nomenclature that achieves the same, similar or equivalent functionality achieved by the various embodiments of the invention.

As mentioned, the various techniques described herein may be implemented in connection with hardware or software or, where appropriate, with a combination of both. As used herein, the terms “component,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

Thus, the methods and apparatus of the present invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computing device generally includes a processor, a storage medium readable by the processor (including volatile and non-volatile memory and/or storage elements), at least one input device, and at least one output device. One or more programs that may implement or utilize the translation capabilities of the present invention, e.g., through the use of a data processing API, reusable controls, or the like, are preferably implemented in a high level procedural or object oriented programming language to communicate with a computer system. However, the program(s) can be implemented in assembly or machine language, if desired. In any case, the language may be a compiled or interpreted language, and combined with hardware implementations.

The methods and apparatus of the present invention may also be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, etc., the machine becomes an apparatus for practicing the invention. When implemented on a general-purpose processor, the program code combines with the processor to provide a unique apparatus that operates to invoke the functionality of the present invention. Additionally, any storage techniques used in connection with the present invention may invariably be a combination of hardware and software.

Furthermore, the disclosed subject matter may be implemented as a system, method, apparatus, or article of manufacture using standard programming and/or engineering techniques to produce software, firmware, hardware, or any combination thereof to control a computer or processor based device to implement aspects detailed herein. The term “article of manufacture” (or alternatively, “computer program product”) where used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally, it is known that a carrier wave can be employed to carry computer-readable electronic data such as those used in transmitting and receiving electronic mail or in accessing a network such as the Internet or a local area network (LAN).

The aforementioned systems have been described with respect to interaction between several components. It can be appreciated that such systems and components can include those components or specified sub-components, some of the specified components or sub-components, and/or additional components, and according to various permutations and combinations of the foregoing. Subcomponents can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described supra, methodologies that may be implemented in accordance with the disclosed subject matter will be better appreciated with reference to the flowcharts of FIGS. 2 and 3. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

Furthermore, as will be appreciated various portions of the disclosed systems above and methods below may include or consist of artificial intelligence or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent.

While the present invention has been described in connection with the preferred embodiments of the various figures, it is to be understood that other similar embodiments may be used or modifications and additions may be made to the described embodiment for performing the same function of the present invention without deviating therefrom. For example, while exemplary network environments of the invention are described in the context of a networked environment, such as a peer to peer networked environment, one skilled in the art will recognize that the present invention is not limited thereto, and that the methods, as described in the present application may apply to any computing device or environment, such as a gaming console, handheld computer, portable computer, etc., whether wired or wireless, and may be applied to any number of such computing devices connected via a communications network, and interacting across the network. Furthermore, it should be emphasized that a variety of computer platforms, including handheld device operating systems and other application specific operating systems are contemplated, especially as the number of wireless networked devices continues to proliferate.

While exemplary embodiments refer to utilizing the present invention in the context of particular programming language constructs, the invention is not so limited, but rather may be implemented in any language to provide methods for translating EDI transaction sets to XML. Still further, the present invention may be implemented in or across a plurality of processing chips or devices, and storage may similarly be effected across a plurality of devices. Therefore, the present invention should not be limited to any single embodiment, but rather should be construed in breadth and scope in accordance with the appended claims.

What is claimed is:

1. A method for translating electronic data interchange (EDI) messages to one or more extensible markup language (XML) representations, including:
receiving at least one interchange including a plurality of EDI transaction sets; and
translating at least two of the plurality of EDI transaction sets to a single XML representation.

2. The method of claim 1, wherein said translating includes translating all of the plurality of EDI transaction sets to the single XML representation such that the ordering of the plurality of EDI transaction sets is preserved.

3. The method of claim 1, further comprising:
determining whether at least one transaction set of the plurality of transaction sets includes invalid EDI data.

4. The method of claim 3, wherein said translating includes rejecting any EDI transaction sets of the plurality of EDI transaction sets that include invalid EDI data when performing said translating if at least one transaction set includes invalid EDI data.

5. The method of claim 3, wherein said translating includes rejecting the plurality of transaction sets comprising the at least one interchange when performing said translating if at least one transaction set includes invalid EDI data.

6. The method of claim 1, further comprising:
configuring a translator component that performs said translating to perform said translating according to a plurality of translation configuration options.

7. The method of claim 6, wherein said configuring includes configuring the translator component to generate a single XML file combining each valid transaction set of the plurality of transaction sets.

8. The method of claim 6, wherein said configuring includes configuring the translator component to generate a single XML file only if all of the plurality of transaction sets are valid.

9. A computer readable medium comprising computer executable instructions for performing the method of claim 1.

10. A computing device comprising means for performing the method of claim 1.

11. A server object that interfaces to one or more electronic data interchange (EDI) trading partners for transmitting and receiving EDI messages, including:
a translation component that translates an interchange including at least two valid transaction sets to at least one extensible markup language (XML) representation; and
a configuration component that receives configuration input that configures the translation component according to an option that causes the translation component to generate a single interchange XML file from the interchange.

12. The server object of claim 11, wherein the configuration component further receives second configuration input that configures the translation component according to an option that causes the translation component to generate multiple XML files.

13. The server object of claim 12, wherein the second configuration input configures the translation component according to an option that causes the translation component to generate multiple XML files, one XML file for each of the at least two valid transaction sets.

14. The server object of claim 11, wherein the interchange further comprises at least one invalid transaction set and said configuration component receives second configuration input that configures the translation component according to an option that causes the translation component to reject the at least two valid transaction sets when combined with said at least one invalid transaction set in said interchange.

15. The server object of claim 11, wherein the configuration component further comprises a user interface component for displaying a user interface for receiving said configuration input.

16. The server object of claim 11, further comprising:
a storage interface for interfacing to relational storage for at least one of storing the single interchange XML file or retrieving the interchange.

17. An electronic data interchange (EDI) messaging system, including:
a translator for translating a group of electronic data interchange (EDI) transaction sets to at least one extensible markup language (XML) file; and
a configuration user interface (UI) for configuring translating by the translator, wherein the configuration UI includes a UI portion that sets an option for rejecting an entire interchange received by a translator if any of said group of EDI transaction sets includes invalid EDI data.

18. The EDI messaging system of claim 17, wherein said configuration UI includes a second UI portion that sets an option whereby the translator generates a single XML file for the group of EDI transaction sets.

19. The EDI messaging system of claim 17, wherein said configuration UI includes a second UI portion that sets an option whereby the translator generates multiple XML files, one XML file for each of the valid transaction sets of the group.

20. The EDI messaging system of claim 17, further including:
an interface component for interfacing to relational storage for at least one of storing the at least one XML file or retrieving the group of EDI transaction sets.
